(19) United States
(12) Patent Application Publication
(10) Pub. No.: US 2012/0078682 A1
(43) Pub. Date: Mar. 29, 2012

(54) CONSUMER RECEIPT INFORMATION METHODOLOGIES AND SYSTEMS

(75) Inventors: David B. Pinsley, Great Neck, NY (US); Paul A. Cantrell, Bentonville, AR (US); Kellen J. Frank, Bentonville, AR (US)

(73) Assignee: THE NPD GROUP, INC., Port Washington, NY (US)

(21) Appl. No.: 13/039,733

(22) Filed: Mar. 3, 2011

Related U.S. Application Data
(60) Provisional application No. 61/387,704, filed on Sep. 29, 2010.

(51) Int. Cl. G06Q 10/00

(52) U.S. Cl. 705/7.29; 705/30

(57) ABSTRACT

This is generally related to techniques for collecting and processing consumer document information. Consumers can transmit documents, such as receipts, to a host system. To transmit the documents, the documents can be scanned with a desktop scanner and transmitted via a web interface, forwarded via e-mail, photographed and transmitted via a mobile phone's e-mail or MMS capability, transmitted via a dedicated smart phone application, etc. Images of the document can be stored in a central archive, such that the consumer can access online images of their documents at any time and from any place. Submitted receipts can be interpreted by the host system to determine receipt information such as merchant, payment method, date, price, coupons, items purchased and/or returned, and the like. The interpreted information can be used to produce a wide range of reports that can be of value to the consumer, the host system, and/or merchants.

### CROSS-REFERENCE TO RELATED APPLICATIONS

This application claims the benefit of U.S. Provisional Patent Application No. 61/387,704 filed on Sep. 29, 2010, which is hereby incorporated by reference herein in its entirety.

### FIELD OF THE DISCLOSURE

This is directed to consumer document information methodologies and systems. In particular, this is directed to systems and methods for submitting consumer documents and generating consumer and/or host reports based on the submitted documents.

### BACKGROUND OF THE DISCLOSURE

Understanding the dynamics of consumer purchase behavior can be valuable to manufacturers and retailers of consumer products and services. Marketing research strives to quantify and provide insight into these purchasing behaviors. In general, some of the most fundamental inputs for the market research can be the facts associated with the consumers' purchases (e.g., where the consumer shops, what the consumer buys, how much the consumer pays, and the like). As such, various techniques have been developed to attempt to collect information about consumers' purchases.

All of these known techniques have inherent limitations, however. Some of them can require a consumer to recall and report what they have purchased after the fact, and there may be limits to the accuracy of what the consumer is able to recall. Another exemplary technique collects data from the “point of sale” (“POS”) by directly capturing limited information at the time a consumer transaction occurs. With this technique, the information collected is limited to the actual purchase made, and the technique may fail to provide any information about the consumer or the purchasing decision process. Yet another technique may ask the consumer to use barcode scanners in their home to record the merchandise they purchased after each shopping trip, but this technique can require the consumer to manually enter pricing information not conveyed by the barcode. Additionally, the consumer may be hesitant to share purchasing information without some form of incentive, such as convenience or compensation, in return.

### SUMMARY OF THE DISCLOSURE

This is directed to consumer receipt information methodologies and systems. A consumer can submit a receipt to a host system through a variety of techniques. For example, a consumer can scan the receipt and then upload it through a web interface. The receipt can be forwarded in an e-mail (e.g., as an attachment or as text within the e-mail). A photograph can be taken of the receipt using a cellular phone or other handheld communication device. The photograph can then be submitted to the host through a multimedia messaging service, through a cellular phone-accessible e-mail account, through a cellular phone-accessible website, or the like. As yet another example, a dedicated smart phone application can be used to take a photograph of the receipt and then automatically upload this photograph to the host system.

Once the host system has received the receipt, the receipt can be processed to interpret it and/or to generate various reports based on the interpreted receipt. For example, the receipt can be analyzed to determine its “receipt component data,” such as the merchant's name, the merchant's address, descriptions of purchased items, prices of purchased items, total prices, payment methods, coupons used, and the like. In some cases, even though a brief description of the purchased item can be provided on the receipt, the exact nature of the transaction may not be readily apparent. For example, the type of transaction may not be readily known (e.g., whether the transaction was a purchase, a return, a sale item, etc.) or the exact item purchased may be unknown (e.g., the particular brand, UPC, or the like may be unknown). Thus, the host system can also interpret the transactions by using a “data dictionary” to determine such information.

In some cases, the host system can interpret transactions by accessing the merchant's system where the purchase occurred. For example, the host system can access information from the merchant's system such as whether or not the purchased items were on sale and, if so, what the normal price would be. As another example, instead of or in addition to directly accessing a merchant's system, the merchant can provide suitable information to the host system as required. For example, the merchant can send information such as sales information, receipt constructions information, or any other suitable information regarding purchases to the host system. The merchant may send such information to the host system at a set interval (e.g., a data dump is performed once a week, once a month, daily, etc), continuously (e.g., a constant data feed is provided to the host system), or as requested (e.g., the host system can submit a request for information when necessary).

Once the receipt has been suitably interpreted, a wide variety of reports can be generated using the receipt's information. For example, reports for the consumer (i.e., “consumer reports”) can be generated to aid the consumer in maintaining a budget, tracking purchases, organizing tax deductible information, and the like. As another example, reports for merchants and/or the host (i.e., “host reports”) can be generated which compare and identify consumer purchasing trends and the like. Such host reports can combine and compare the reports of multiple consumers to determine broad market trends such as demographic buying trends, geographic buying trends, returned item trends, coupon usage, sales item purchases (e.g., and whether such sales item purchases result in other items being purchased or result in an overall profit for the merchant), popularity trends, items purchased on impulse, purchased items that are necessities for the consumers, purchased items that are “wants” rather than necessities for the consumers, and the like.

### BRIEF DESCRIPTION OF THE DRAWINGS

The above and other features of the invention, its nature and various advantages will be more apparent upon consideration of the following detailed description, taken in conjunction with the accompanying drawings in which:

FIG. 1 shows a schematic view of an illustrative consumer device in accordance with some embodiments of the invention;

FIG. 2 shows a schematic view of an illustrative consumer and host communication network in accordance with some embodiments of the invention;

FIG. 3 show an illustrative flowchart for processing receipts that can be performed on a consumer end and on a host end in accordance with some embodiments of the invention;

FIG. 4 shows an illustrative system for generating reports from consumer receipt information in accordance with some embodiments of the invention;

FIG. 5 shows an illustrative process for a host system to receive receipts via e-mail in accordance with some embodiments of the invention;

FIG. 6 shows an illustrative web interface for confirming a receipt interpretation in accordance with some embodiments of the invention;

FIG. 7 shows an illustrative data structure for a final receipt data archive of a host system in accordance with some embodiments of the invention;

FIG. 8 shows an illustrative process for processing digitized documents and generating reports in accordance with some embodiments of the invention; and

FIGS. 9 and 10 show illustrative web interface for submitting and processing receipts in accordance with some embodiments of the invention.

### DETAILED DESCRIPTION

This is directed to systems and methods for developing consumer receipt information. For example, in some embodiments a consumer can provide a digitized receipt of a purchase to a host system. The host system may then process and interpret the receipt to pull various types of receipt data from it. For example, receipt data such as merchant name, purchase date, merchandise purchased, prices, coupons used, and the like can be pulled from the receipt. The host system may use the receipt data to generate a wide array of reports. For example, reports for the consumer (i.e., “consumer reports”) can be generated to aid the consumer in maintaining a budget, tracking purchases, organizing tax deductible information, and the like. As another example, reports for merchants and/or the host (i.e., “host reports”) can be generated which compare and identify consumer purchasing trends and the like. In this manner, since a consumer can receive informative consumer reports in exchange for providing receipt information, a consumer can be incentivized to share and report their purchasing information to the host system. Additionally, the host reports can provide the host and/or merchants with valuable marketing information that is accurate and readily obtained from the consumer.

As used herein, the term “consumer” refers to any entity who purchases merchandise, thereby receiving a receipt in return for the purchase. Moreover, as used herein, the term “merchant” refers to a vender who sells merchandise to a consumer and generates a receipt for the consumer. A “host” or “host system,” as used herein, refers to a system which can suitably process the receipts and generate reports based on the receipt's data (e.g., and the reports may also be based on additional data). Moreover, although the particular example of processing receipts and generating reports from receipts may be described herein, one skilled in the art could appreciate that the systems and methods described herein could alternatively or additionally be applied to any suitable documents. For example, documents such as bills, travel itineraries, insurance information, warrantees, and the like could be processed to generate suitable reports regarding consumer purchases. Moreover, instead of or in addition to being used to generate reports, such documents could be stored in an online format that is easy and convenient for a consumer to access.

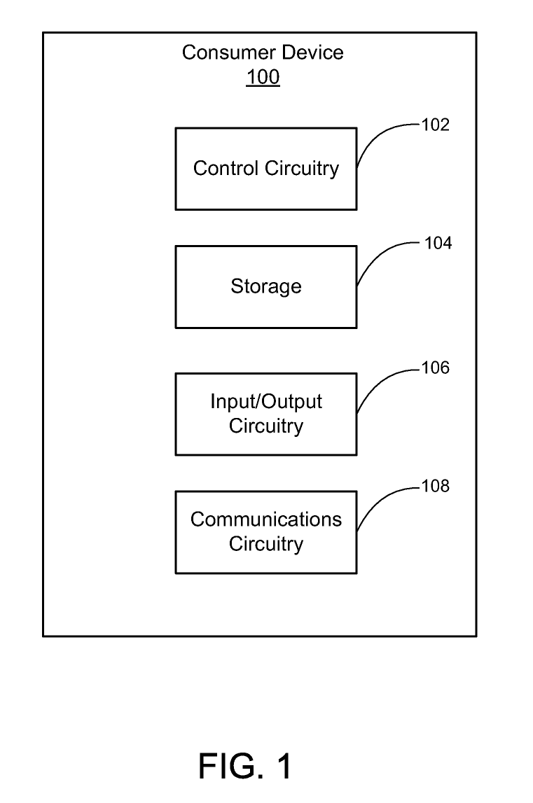

FIG. 1 shows consumer device 100. Consumer device 100 can be any suitable device or system used by the consumer for digitizing a receipt and/or transmitting the digitized receipt to a host. For example, consumer device 100 could include a desktop computer, a laptop, a cellular telephone, a personal data assistant (“PDA”), a video gaming device, a media player, a scanner, or any other suitable consumer device. Consumer device 100 can include, for example, control circuitry 102, storage 104, input/output (“I/O”) circuitry 106, and communications circuitry 108. While only one of each component is shown in FIG. 1 for simplicity, one skilled in the art could appreciate that any suitable number of components or any additional components (e.g., such as a global positioning assistant, or the like) could alternatively be included in consumer device 100.

Control circuitry 102 can include any suitable processor or other control circuitry for controlling the operations of consumer device 100. For example, control circuitry 102 can run software applications, run an operating system, control the flow of data in and out of storage 104, instruct I/O circuitry 106 to receive and present data, control the transmittal of information via communications circuitry 108, and the like.

Storage 104 can include, for example, one or more storage mediums including a hard-drive, solid state drive, flash memory, permanent memory such as ROM, temporary memory such as RAM, or any other suitable type of storage component. For example, prior to being transmitted to a host system, storage 104 may hold a digitized receipt in temporary (e.g., in RAM) or long-term (e.g., in a hard drive) storage.

The digitized receipt can be received by consumer device 100 from the consumer through I/O circuitry 106. For example, I/O circuitry 106 can control any device suitable for digitizing a receipt, such as a scanner, a digital camera, or the like. I/O circuitry 106 can also control any other suitable input or output devices such as, for example, a keyboard, a mouse, a display screen, speakers, and the like.

Communications circuitry 108 can include any suitable communications circuitry operative to connect to a communications network and transmit or receive data with consumer device 100. For example, communications circuitry 108 can transmit a digitized receipt to a host system, receive consumer reports from the host system, and so forth. Communications circuitry 108 can interface with a communications network using any suitable wired (e.g., LAN) or wireless communications (e.g., WiFi, a cellular network, and the like).

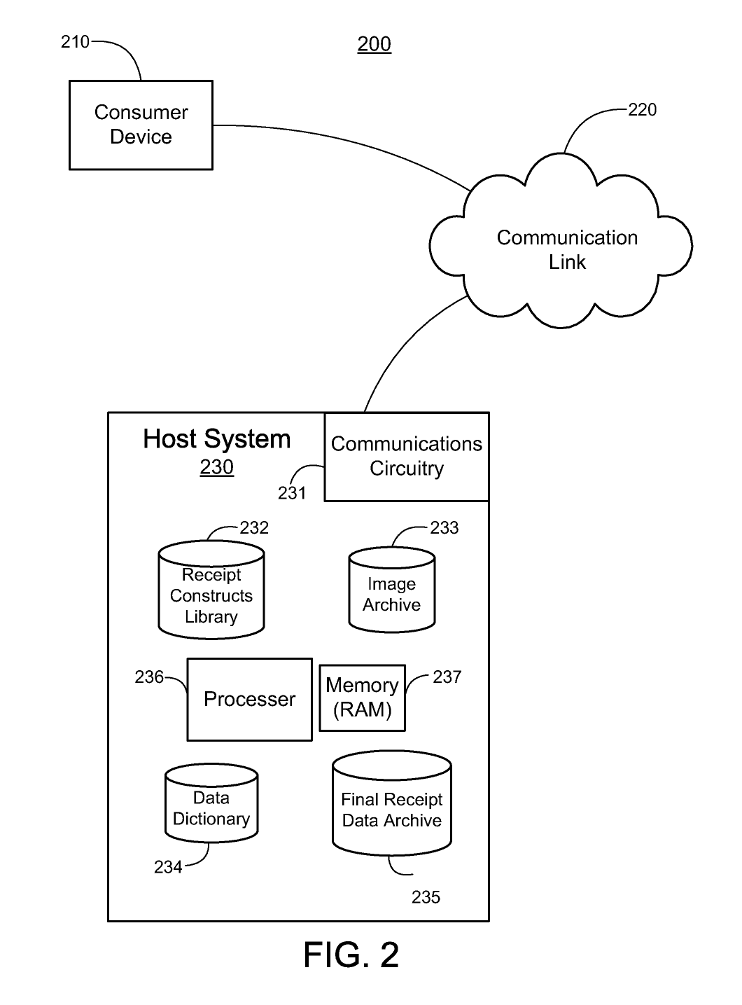

FIG. 2 shows communication system 200 for communicating information to and from a consumer device and a host system. For example, communication system 200 can include consumer device 210 that communicates via communication link 220 with host system 230. Consumer device 210 may, for example, correspond to consumer device 100 of FIG. 1. Communication link 220 can include any suitable wired or wireless network for transmitting information between consumer device 210 and host 230. For example, communication link 220 can include a network using any suitable communications protocol such as LAN, WAN, fiber optics, WiFi, Bluetooth®, radio frequency systems (e.g., 900 MHz, 2.4 GHz, and 5.6 GHz communication systems), infrared, cellular protocols, or any other suitable protocol. Communication link 220 can provide for communication between communications circuitry 231 of host system 230 and communications circuitry of consumer device 210 (e.g., communications circuitry 108 of FIG. 1) to transmit digitized receipts and/or reports between consumer device 210 and host system 230.

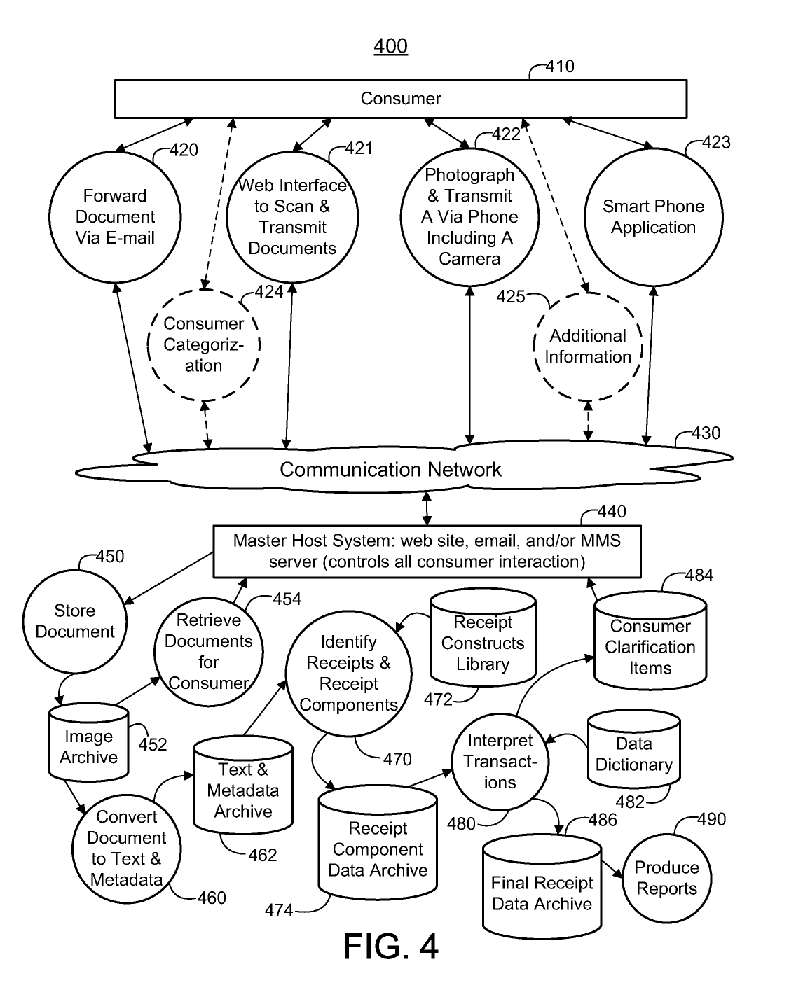

Host system 230 can include various storage systems, such as receipt constructs library 232, image archive 233, data dictionary 234, and final receipt data archive 235, as well as other similar systems. These storage systems and the particular data they may hold will be described in greater detail with regards to FIG. 4 and in the descriptions to follow. Host system 230 can also include processor 236 that can perform any suitable processing of the digitized receipts (e.g., that were received via communications circuitry 231). For example, as will be described in greater detail below, processor 236 can store the digitized receipts in image archive 233, interpret the digitized receipts to extract relevant receipt data, and/or generate reports with the receipts data. Moreover, host system 230 can include one or more instances of temporary memory 237 (e.g., such as RAM) that may temporarily store information used by processor 236 in processing the consumer's digitized receipts.

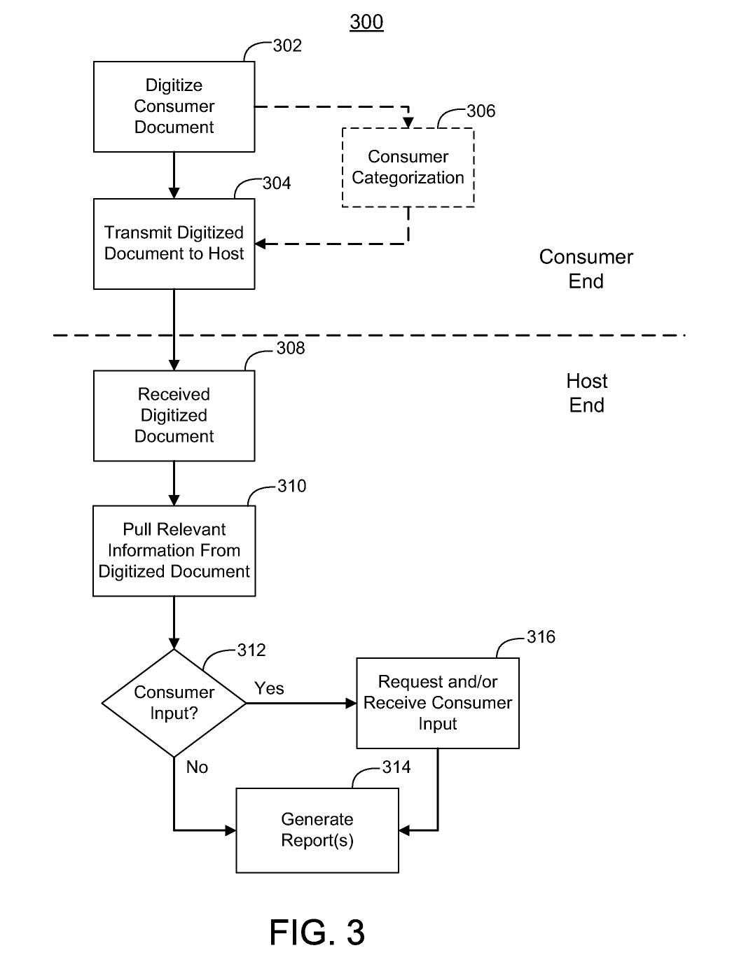

FIG. 3 shows a representation of simplified process 300 that can illustrate how consumer device 210 and host system 230 of FIG. 2 may interact. For example, in process 300, steps 302, 304, and 306 can correspond to a consumer end of process 300 whereas steps 308, 310, 312, 314, and 316 can correspond to a host end of process 300.

At step 302, the consumer document can be digitized. The consumer document can include, for example, a receipt, a bill, a trip itinerary, or any other suitable document transmitted to and processed by the host system. The consumer document can be digitized in any suitable manner. For example, the consumer document can be scanned using a scanner, a digital photograph can be taken using a digital camera, a camera phone, a webcam, or any other suitable device can be used to digitize the document. In some cases, the receipt may have been received by the consumer in an online format. For example, after making an online purchase, a consumer may receive a receipt via email or may receive a confirmation screen on their web browser. Thus, in this case, the receipt may already be in a digital format while in its original form. In such situations, step 302 may, for example, simply correspond to the consumer receiving the receipt via email, via display upon a web browser, or via any other digital format.

The digitized document may then be transmitted to the host system at step 304. For example, the digitized document can be transmitted via communications circuitry 108 of FIG. 1. Moreover, the digitized document can be transmitted via any suitable communications scheme such as, for example, via e-mail, multimedia messaging services (“MMSs”), dedicated smart phone applications, uploading through a web interface, or any other suitable communications scheme. Such communications schemes will be described in greater detail with regards to FIG. 4 and the descriptions to follow.

In some embodiments, an optional step 306 can be provided that allows a consumer to add categorization information to the digitized document. For example, the categorization information can be transmitted along with the digitized document to the host system and used in any suitable processing of the digitized document. As an illustration, the consumer may categorize one or more purchases on the digitized receipts as tax deductible purchases, as travel reimbursable purchases, as purchases including warrantees, and the like. Reports that are subsequently generated by the host system may then use this categorization information to create reports with enhanced information for the consumer. For example, reports can be generated that conveniently list all tax deductible purchases to aid a consumer in filing their tax returns. As another example, reports can be generated that list travel reimbursable purchases to aid a consumer in easily requesting travel reimbursement from their workplace. As yet another example, a report can be generated which locates the receipt (e.g., an image of the receipt) for a purchased item that is under warranty, thus potentially helping the consumer enforce a warranty on a defective or broken item.

At step 308, the digitized document may be received by the host system. For example, the digitized document can be received via communications circuitry 231 of host system 230 (FIG. 2). In some embodiments, upon receiving the digitized document the host system may also store an image of the digitized document in a consumer-accessible archive. For example, the image can be stored in image archive 233 of host system 230 (FIG. 2).

Relevant information may then be extracted from the digitized document at step 310 using any number of techniques. For example, optical character recognition (“OCR”) techniques can be used to determine the document's text when the digitized document is a scanned document or is a digital photograph, or HTML parsing techniques can be used to determine the document's text when the digitized document is forwarded via e-mail, uploaded directly to the host system via a website, and the like. The determined text may then be analyzed to identify relevant information in the digitized document. For example, in the scenario where the digitized document is a receipt, information such as the merchant name, merchant address, date of purchase, purchased items, quantity of items purchased, price of each item purchased, total price, tax information, coupons used, method of payment, returned item information, loyalty account information, or any other suitable receipt information can be extracted. In particular, the information that is extracted from the digitized document can include information that is of value to the consumers and/or that is of value to marketing researchers. The information that is of value to the consumers may subsequently be used, for example, in generating consumer reports while the information that is of value to marketing researchers may subsequently be used, for example, in generating host reports.

In some embodiments, in addition to the information extracted in step 310, it may be beneficial to obtain consumer input regarding the digitized document. For example, the host system may be unable to identify all of the text in a digitized document (e.g., the host system may be unable to locate the merchant's name on the receipt). Thus, the host system can determine at step 312 that consumer input is required. In response, at step 316, the consumer may be requested to manually enter the merchant's name or other information (e.g., or clarify any other issues regarding the digitized document that the host system was unable to resolve). As another example, if consumer categorization was not provided in step 306, the host system may optionally prompt the consumer to provide such categorization information at step 316. As yet another example, at step 316 the consumer can be requested to provide additional information regarding the purchases such as whether the purchase was a “need,” a “want,” or an “impulse” purchase, and/or to provide demographic information regarding the consumer, and the like. In some embodiments, the host system may simply always prompt the consumer to provide additional information. In this case, step 312 may be omitted and process 300 may simply proceed from step 310 to step 316.

At step 314, reports can be generated using the information pulled from receipt (e.g., or any other digitized document) at step 314 and/or any consumer input received at steps 306 and/or 316. For example, consumer reports can be generated that manipulate the receipt information to provide informative and helpful data to the consumer. This can include reports which: sort purchases (e.g., by date, by item name, by price, and the like); search the purchases for desired criteria such as price, merchant name, time period, and the like (e.g., all purchases over $100, all purchases from Macy's, all purchases in May of 2010, etc.); list tax deductible purchases; list travel expense purchases; show a calendar listing of purchasing information (e.g., shows which merchants were visited on which days, how much money was spent on which days, and the like); or any other suitable consumer reports.

In addition to consumer reports, host reports can be generated at step 314. Such host reports can, for example, analyze consumers' purchases to generate reports related to marketing trends and purchasing behavior. The host reports can be generated based on a single consumer's purchases (e.g., to provided targeted host reports) or based on a large number of consumers' purchases (e.g., to provide reports indicating broad market trends). For example, such host reports can combine and compare the reports of multiple consumers to determine market trends such as demographic buying trends, geographic buying trends, returned item trends, coupon usage, sales item purchases (e.g., and whether such sales item purchases results in other items being purchased or result in an overall profit for the merchant), popularity tends, items purchased on impulse, purchased items that are necessities for the consumers, purchased items that are “wants” rather than necessities for the consumers, and the like. In some embodiments, the host system may generate such host reports for their own marketing research use. In some embodiments, the host system may generate the host reports for use by other entities. For example, rather than using the reports themselves, the host system may instead generate and sell the host reports to various merchants for the merchants' own marketing research.

In this manner, through process 300, the host system can provide a scheme that can be beneficial and appealing to both the host and the consumer. For example, the host system can provide the consumer with services such as an image archive of the consumer's receipts that is easily accessible online, access to consumer reports, access to receipt search features, access to receipt sort features, access to receipt tagging features (e.g., such that the consumer can later find receipts for noteworthy purchases and/or tax issues) and the like. These services can be provided to the consumer in exchange for allowing the host to access the consumer's purchasing information. The host thus also benefits by readily having access to information that accurately portrays consumers' buying preferences and habits. This information may be invaluable to the host in performing marketing research and/or in identifying various marketing trends.

FIG. 4 shows system 400 for generating reports from consumer receipt information. For example, system 400 may illustrate possible structures for carrying out process 300, as well as illustrating steps of process 300 in greater detail. As illustrated by FIG. 4, a consumer 410 can digitize and forward a document via communication network 430 to host system 440. Based on the way in which the digitized receipt is sent, communication network 430 can include any suitable network such as, for example, a cellular network, an internet network, or any other suitable communication network. Moreover, as discussed previously, the document can include any suitable document such as bills, travel itineraries, insurance information, and the like. However, while the particular example of a receipt may be referred to herein, this is for the purpose of illustration and not of limitation. Rather, one skilled in the art could appreciate that when a receipt is described, any other suitable document could alternatively be used.

Consumer 410 may digitize and forward the receipt to host system 440 via a variety of techniques. For example, consumer 410 may: forward an e-mail to host system 440 that includes a digitized receipt (e.g., technique 420); scan and transmit a receipt via a dedicated web interface (e.g., technique 421); photograph and transmit the receipt via a smart phone or other handheld communication device/phone including a camera (e.g., technique 422); photograph and transmit the receipt via a dedicated smart phone application (e.g., technique 423); use any other suitable technique, or any combination of the above.

As described by technique 420, consumer 410 may simply forward an e-mail to host system 440 that includes a digitized version of the receipt. In some embodiments, consumer 410 may register their e-mail address with host system 440. For example, host system 440 may have a website that organizes consumer receipts and generates reports based on the receipts, and consumer 410 may register their e-mail address when signing up for an account with this website. Host system 440 may then provide an e-mail address to which consumer 410 should e-mail their receipts. When host system 440 receives an e-mail including a receipt, the sender's e-mail address can be matched to a database of registered e-mail addresses to determine which consumer is forwarding the receipt. The receipt may then be saved online in that consumer's account (e.g., in a receipt image archive corresponding to that consumer) and used in generating any consumer reports for the consumer.

In this manner, the consumer can upload receipts to host system 440 by simply sending an e-mail. The host system may then autonomously recognize the consumer's e-mail address and save the receipt in the consumer's corresponding account. Thus, technique 420 may especially be appealing when the receipts are originally in a digital form such as, for example, when a consumer purchases an item online and receives the corresponding electronic receipt via e-mail (e.g., or when a consumer makes an in-store purchase and receives a copy of the receipt via e-mail). In this case, the consumer can upload the receipt to host system 440 with minimal effort—simply by forwarding the e-mail already containing the digitized receipt to host system 440. Alternatively, the consumer can digitize a hard copy of the receipt in any suitable manner, and then forward the digitized receipt via e-mail. For example, the consumer can scan the receipt and then forward the receipt (e.g., as a .pdf file, as a .tif file, or as any other file type of a scanned image), the consumer can take a digital photograph of the receipt (e.g., as .jpg file, or as any other image file type), and then attach the digitized receipt to an e-mail. Moreover, host system 440 can be enabled to receive a wide variety of file types, such that the consumer does not need to select a particular file type when scanning or otherwise digitizing the receipt. This can once again allow the consumer to provide digitized receipts to host system 440 with minimal effort.

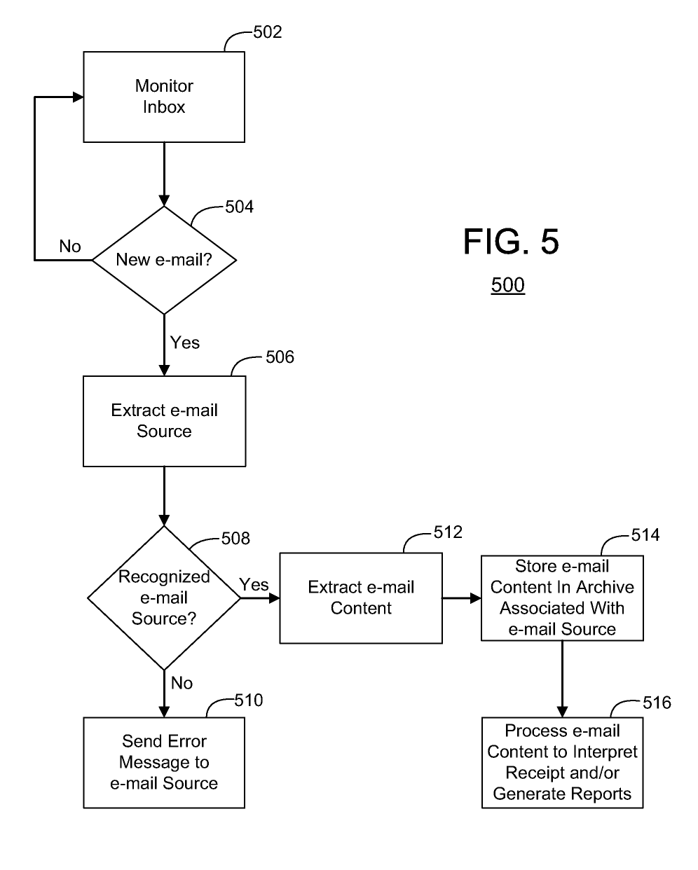

In order to receive receipts from consumers via e-mail, host system 440 may monitor an e-mail inbox and extract any receipts that are received. For example, FIG. 5 shows a representation of process 500 for enabling a host system to receive receipts via e-mail. At step 502, the host system can monitor an e-mail inbox for new e-mails. For example, the host system may monitor an inbox associated with an e-mail address that was provided to the consumers for submitting receipts. In some embodiments, the host system can monitor the inbox continuously, such that a new e-mail is immediately located upon receipt. Alternatively, in some embodiments the host system may check the inbox once every set period of time. For example, the host system may check the inbox every minute, every 5 minutes, every hour, or check the inbox at any other suitable time interval.

Upon checking the inbox (e.g., where the inbox is checked continuously, checked at a set rate, or the like), at step 504 the host system can determine whether there are any new e-mails. In response to there being no new e-mails, process 500 may return to step 502 and the host system may continue to monitor the inbox. In response to there being a new e-mail, however, the “e-mail source” can be extracted from the new e-mail at step 506. For example, the e-mail source can refer to the e-mail address from which the new e-mail was sent.

The host system may then determine whether the extracted e-mail source is recognized at step 508. For example, consumers may be required to register one or more e-mail addresses, which may then be linked to the consumer's account. The host system may keep a record of all registered e-mail addresses. At step 508, the host system may compare the e-mail source to this record of registered e-mail addresses. If the e-mail source does not match a registered e-mail address, the host system may then reply to the e-mail source with an error message (e.g., at step 510). For example, such a scenario may occur when a consumer sends a receipt to the host system using an e-mail address which they have not yet registered with the host system. In this case, in order to alert the consumer of this error, the host system may reply to the consumer with a suitable error message. As an illustration, an e-mail including an error message such as “Thank you for this receipt. Unfortunately, we do not recognize the sender's e-mail address. Please register this e-mail address with your account and/or re-send the receipt using an e-mail address you have already registered” can be sent. Alternatively or additionally, the host system could send a message to the consumer including a link which, if the consumer clicks the link, register that e-mail address and accepts the submitted receipt (e.g., and/or prompts the consumer to provide more information for registering the e-mail address to a new account or linking the e-mail address with an already-registered account).

In response to the e-mail source being recognized, however, the host system may proceed to process the e-mail and its forwarded receipt. For example, at step 512 the e-mail content can be extracted. The “e-mail content” can include any suitable portions of the e-mail which relate to the receipt. For example, when the receipt is forwarded as an e-mail attachment (e.g., when the consumer scanned the receipt or took a digital photograph of the receipt), then the e-mail content can be extracted by downloading the e-mail attachment. In this case, the e-mail content can be any suitable attachment file type such as, for example, .pdf, .doc, .jpg, .bmp, .tiff, or any other suitable file type. As another example, the receipt may be forwarded in the text of the e-mail. This situation may occur, for example, when the consumer purchases an online item, receives an e-mail confirmation of the receipt, and then forwards this e-mail to the host system. In this case, the e-mail content can include the text of the e-mail, encoded HTML, or any other suitable information included in the text. In some embodiments, the host system can determine e-mail content that does not relate to the receipt and decline to extract such information (e.g., or simply discard such information). For example, the host system may determine that part of the e-mail is the consumer's signature and therefore does not relate to the receipt.

After extracting the e-mail content, the e-mail content may then be stored in the consumer's account at step 514. For example, the e-mail content can be stored in an image archive (e.g., image archive 233 of FIG. 2) that is associated with the e-mail source extracted at step 506. In some embodiments, in order to maintain uniformity the e-mail content may first be converted to a particular file type. For example, the host system may convert all e-mail content to an image file and then save this image file in the image archive. In such an instance, the stored image could be tagged with the consumer's e-mail address or other identifying information. Alternatively, in some embodiments the e-mail content may be saved in its original form (e.g., as text, html, .pdf, .jpg, or the like). The consumer may then be able to access the image archive to view their receipts at any time. In this manner, the consumer can be provided with a useful and practical means for viewing and accessing their purchasing history, and can even be provided with the capability to flag certain receipts corresponding to, for example, large purchases such as a flat screen television.

At step 516, the e-mail content can be processed to interpret the receipt and/or generate reports. For example, the e-mail content can be interpreted to identify the various receipt components in the e-mail content (e.g., merchant name, purchase date, purchased items, prices, etc.), consumer reports can be generated, and/or host reports can be generated. The various ways in which the e-mail content can be interpreted and processed will be discussed in greater detail with regards to FIG. 4 and in the corresponding descriptions to follow.

Returning to FIG. 4 and to ways in which a consumer can forward receipts to host system 440 (e.g., techniques 420-423), a consumer may additionally forward receipts using a dedicated web interface and a scanner, as illustrated by technique 421. For example, a web interface can be provided that communicates directly with a consumer's scanner. As an illustration, the consumer may access the web interface, and choose an option listed therein to add a new receipt. In response, the web interface can direct the consumer's scanner to begin scanning the receipt and, once the scanning is completed, automatically upload the scanned receipt to the web interface and into the consumer's account. The web interface may then process the receipt in any suitable manner (e.g., store the receipt, interpret the receipt, generate reports, or the like).

Thus, from the consumer's perspective, technique 421 can provide a seamless and user-friendly system that scans, uploads, and processes receipts with minimal interaction on the consumer's end. Moreover, this technique can facilitate receipt scanning without the need for locally-installed application software. Rather, in some embodiments it may only be necessary for the consumer to install a device driver on their own system. The web interface may then directly interact with this device deriver on the consumer's local computer, and may collect and transmit the scanned receipt's image through the internet and into server storage (e.g., into storage such as image archive 233 of FIG. 2). Additionally, in some cases the web interface itself can install a suitable device driver on the consumer's computer, thus further simplifying the setup process. The scanner used to digitize the receipt can be a scanner personally owned by the consumer, or in some cases the host may even send a scanner to the consumer to use. For example, the host may mail a scanner to the consumer in response to the consumer setting up an account with the web interface.

Additionally, a technique such as technique 421 could be equally applied to situations when a consumer digitized a receipt using a digital camera, or the like. For example, the web interface may directly communication with a consumer's digital camera through the use of a device driver. Accordingly, when the consumer selects a suitable input on the web interface (e.g., such as an input to “add a new receipt”), the web interface may direct the digital camera to take a picture of the receipt and then automatically upload this picture.

In some cases, a consumer can forward a receipt to host system 440 using a handheld communication device with a digital camera. For example, as illustrated by technique 422, a receipt can be forwarded using a cellular telephone including a camera, using a personal e-mail or messaging devices (e.g., a Blackberry™) including a camera, or using any other suitable handheld communication device with digital photography abilities. Moreover, although the embodiments described herein may discuss the particular example of forwarding a receipt using a cellular phone, this is for the purpose of illustration and one skilled in the art could appreciate that any other suitable handheld communication device could alternatively be used.

Using the embedded camera and intrinsic software found in cellular phones, a consumer could take a picture of a receipt. Using the same cellular phone, the picture may then be forwarded to the host system using a variety of mechanisms. For example, the picture can be sent through the cellular phone as an attachment in an e-mail message. As another example, the picture can be transmitted via a Multimedia Message Service (“MMS”). MMS is a standard method of transmitting multimedia (e.g., graphics, video clips, sound files, text messages, and the like) over wireless networks. In general, since the image quality and resolution of cameras in handheld communication devices is steadily improving and has already reached a high-quality level, the host system can be capable of suitably reading and interpreting receipts received from handheld communication devices. However, in some cases, a consumer can be requested to test and/or calibrate their handheld communication device prior to use to determine whether the quality of the device's camera is sufficient.

Host system 440 may receive and interpret receipts via technique 422 in the same manner that receipts are received and interpreted via e-mail (i.e., technique 420). For example, with some alterations, process 500 of FIG. 5 may also be used to receive receipts from handheld communication devices. For example, at step 502, a MMS inbox may be monitored instead of an e-mail inbox when the receipt's image is forwarded via MMS. Similarly, steps 512, 514, and 516 may instead manipulate MMS content rather than e-mail content when the receipt is forward via MMS. As another example, a consumer's phone number can be registered instead of registering a consumer's e-mail address. Thus, steps 506, 508, and 510 may alternatively process a “phone number source” instead of an e-mail source.

In some embodiments, the digitized receipt can be forward via a dedicated smart phone application (e.g., technique 423). Many cellular phones today are “smart” phones that offer enhanced features and computing capabilities over normal cellular phones. For example, such smart phones often include a wide range of software applications that can be installed on the phone. Thus, host system 440 can provide the consumer with a dedicated smart phone application for capturing receipt images and uploading the images to the consumer's account (e.g., in a single step). For example, a consumer may access the smart phone's application and choose an option to photograph the receipt. In response, the application may then automatically direct the cellular phone to take a photograph of the receipt, direct the cellular phone to upload the photograph to the host system, and direct the host system to perform any suitable processing of photograph (e.g., interpreting the receipt, generating reports, saving the receipt's image in an image archive associated with the consumer, and the like).

Thus, in this manner, techniques 420, 421, 422, 423, and/or any other suitable techniques can be used to forward digitized receipts to host system 440 through communication network 430. In some embodiments, consumer 410 may optionally provide consumer categorization information 424 and/or additional information 425 to host system 440. Consumer categorization information 424 can include any suitable information to aid the consumer in categorizing or organizing purchases on the receipts. For example, certain purchases and/or entire receipts can be marked as tax deductible expenses, work travel expenses, purchased items including a warranty, or the like.

Additional information 425 can include information that host system 440 requests from the consumer. For example, additional information 425 can include information host system 440 requires in order to clarify a receipt (e.g., host system 440 cannot locate the merchant name on the receipt, and requests the consumer to manually provide this information) and/or can include information host system 440 requests in order to aid in marketing research. For example, host system 440 may request the consumer to indicate whether certain purchases are “wants,” “needs,” or “impulse purchases,” may request demographic information regarding the consumer, or the like.

Consumer categorization information 424 and additional information 425 can be provided to host system 440 at any suitable time and in any suitable manner. For example, the information may be sent in an e-mail (e.g., as text or as an attachment), sent via a text message, input through a web interface of the host system, input through a dedicated smart phone application, or the like. As an illustration, when setting up an account with the web interface, the consumer may be prompted to provide demographic information in their user profile. In this case, the consumer may provide additional information 425 merely a single time (e.g., when setting up their account). As another illustration, when forwarding a receipt as an e-mail attachment, the consumer may type whether the purchases were a “want” or a “need” into the e-mail subject line or body. In this case, the consumer may have the option of providing the additional information every time a receipt is forward to host system 440. Host system 440 may then extract this additional information at the same time the e-mail content is extracted.

Thus, consumer 410 can transmit their digitized documents to host system 440 via a wide variety of techniques. Host system 440 may then receive the digitized documents in real time or near-real time. As shown by step 450, upon receiving the digitized documents, host system 450 may store the digitized documents in “raw form” on the central server in image archive 452. For example, in some embodiments, the raw form can include the original format in which the digitized document was received or extracted. As an illustration, this can include an image file in cases where the consumer transmitted a digital photograph of the document, HTML or text in cases where the receipt is included in the body of an e-mail or text message, a PDF or Word document or other suitable file type in cases where the receipt is included as an attachment to an e-mail, and the like. In other embodiments, for uniformity all digitized documents can be converted to a same file type prior to storing them in image archive 452. For example, host system 440 may convert all received digitized document to an image file type (e.g., .bmp, .jpg, .tiff, or any other suitable file type) such that only one type of file is stored in image archive 452. In particular, the embodiments provided herein may refer to the “images” or “image files” of the digitized documents being stored in image archive 452. However, this is for the purpose of illustration and one skilled in the art could appreciate that the digitized documents could alternatively or additionally be stored as any suitable file type in image archive 452.

As images of a consumer's receipts can be conveniently stored in image archive 452, a consumer can be provided with the ability to examine any and all receipts (e.g., or other digitized documents) that they have submitted at any time. For example, as shown by step 454, receipt images can be retrieved from image archive 452 and provided to consumer 410 through communication network 430. This valuable aspect of system 400 can provide many benefits to the consumer. For example, host system 440 can provide a web interface that allows the consumer to readily access their submitted receipts online from any location. From this web interface, the consumer can also search their receipts, filter various dimension (e.g., show purchases over a certain dollar amount, show purchases made on a certain date, show purchases from a certain merchant, and the like), and view receipts they have previously submitted. In some embodiments, the web interface can include feedback such as feedback showing which merchants the consumer visited on which days. This feature may additionally encourage the consumer to be thorough and complete in submitting their receipts or other digitized documents.

In this manner, the consumer can be provided with many valuable tools and features for organizing, viewing, and understanding their purchasing behavior. This in turn may aid the consumer in preparing household budgets or managing their finances. Thus, the consumer can be incentivized to share their receipts and other purchasing information with host system 440, who in turn can benefit by having access to purchasing behavior information valuable in conducting market research.

As mentioned above, consumer 410 and/or host system 440 can be provided with various features for managing and manipulating the digitized documents, such as generating reports, searching the digitized documents, sorting the digitized documents, tagging the digitized documents, and the like. In order for host system 440 to provide these features, it may be necessary to first “read” the documents or otherwise determine what information is contained in the documents. For example, as shown by step 460, the digitized documents can be converted to text and/or metadata. The “text” can refer to the letters, numbers, symbols, and/or any other characters that are derived from the digitized documents (e.g., the actual words on the receipt). In some embodiments, the text can be stored as the ASCII representation of these characters, or as any other suitable character representation. The “metadata” can refer to any contextual information about the text, such as where on the digitized document the various text elements are located. As will be described in greater detail below, both the text and metadata can be used for subsequent processing and interpreting of the digitized documents.

The text and metadata can be read from the digitized documents in any suitable manner. For example, in some cases software applications such as Optical Character Recognition (“OCR”) programs can be used to automatically identify the text and metadata. As another illustration, in some cases this information can be manually entered. For example, employees can be hired to read the images stored in image archive 452 and manually enter the text and/or metadata. In this case, data encryption or other security features can be enacted to protect the consumer's information when such a third party will be dealing with the digitized documents. As another illustration, in some cases a combination of OCR and manual entry can be used. In this case, the manual entry can function as a quality control measure to double-check that the OCR function is reading the digitized documents correctly. Once the text and metadata has been sufficiently determined from the digitized receipt, it can be stored in text & metadata archive 462.

At step 470, host system 440 can identify which of the digitized documents are receipts. The “receipt component data” can then be pulled from the identified receipts by using receipt constructs library 472. The receipt constructs library 472 can include a database describing the structure of various types of receipts, where the types of receipts can be organized by merchant. For example, receipts constructs library 472 can include information defining that, for the merchant “JazzyGem Supermarkets” the merchant name is located in the first line of text at the top of the receipt, the merchant address is located in the second and third line of text on the receipt, the purchased items are located in a column on the left hand side of the receipt, and so forth. Similar information can be stored in receipt constructs library 472 relating to a large selection of merchants. The information in the receipt constructs library 472 can be determined by, for example, buying this information from various merchants, analyzing merchant receipts to determine the information, and so forth.

Thus, by using the receipts constructs library 472 coupled with the text and metadata (e.g., determined at step 460), the receipt can be broken down to determine its receipt component data. In other words, the receipt component data can include information linking key items of text in the receipt to their meaning For example, the receipt component data can identify information such as the text indicating the date of purchase, the text indicating the time of purchase, the text indicating the total price, the text indicating the payment method, the text indicating coupon information, the text indicating a returned item, the text indicating loyalty card information, the text indicating tax information, the text indicating sales items, the text indicating an array of details associated with the purchased items (e.g., the item description, the item quantity, the price of the item, and the like), and any other suitable receipt information. This receipt component data may then be stored in receipt component data archive 474.

Oftentimes, products that a consumer has purchased may only be described briefly or in a shorthand manner on the receipt. Thus, even though the description of a purchased product may have been identified at step 470 (e.g., and stored as receipt component data), this information may be insufficient to exactly identify the purchased product. As an illustration, a receipt may describe a purchased product as “Blk Sprg Drss” on the receipt. This description can be rather vague, and even if a person can decipher that this description is referring to some type of “black spring dress,” it can still be uncertain which exact dress this is (e.g., and a computer may have an even more difficult time identifying the exact product). Rather, in order to exactly identify the unique product, the product transactions can be interpreted at step 480 using data dictionary 482. For example, data dictionary 482 can include information linking product descriptions found on receipts to a unique identifier for that product, such as a universal product code (“UPC”), stock keeping unit (“SKU”) code, a brand and item number, or the like. Thus, in the example described above, data dictionary 482 can interpret that “Blk Sprg Drss” on a Macy's receipt refers to a black spring dress with SKU code 484484 manufactured by Guess Clothing Inc.

Thus, data dictionary 482 can include information for uniquely identifying a product transaction that is described on a receipt (e.g., such that the brand and product is exactly known). Data dictionary 482 can also include information to identify various types of transactions. For example, a wide variety of transaction types can be included on a receipt, such as an item purchase, an item return, the use of a coupon, the use of a sale, or any other suitable type of transaction. Data dictionary 482 can thus include information for correctly identifying each type of transaction.

Moreover, since available products and transactions types are constantly changing, data dictionary 482 can be continuously updated to improve the match rate as well as to maintain current and accurate information regarding new items for sale. In some embodiments, the information in data dictionary 482 can be directly received and/or purchased from the merchants (e.g., the merchants can sell host system 440 a listing of receipt descriptions and their corresponding UPCs and/or transaction types). For example, in this case the merchant can send information such as sales information, receipt constructions information, or any other suitable information regarding their purchases to host system 440. The merchant may send such information to host system 440 at a set interval (e.g., a data dump is performed once a week, once a month, daily, etc), continuously (e.g., a constant data feed is provided to host system 440), or as requested (e.g., host system 440 can submit a request for information when necessary). Host system 440 may then use the information received from the merchant in order to build data dictionary 482, build receipt constructs library 472, and/or build any other suitable library. Alternatively or additionally, host system 440 can build the data dictionary independently by manually comparing receipt descriptions to the purchased items in order to interpret the transactions. Furthermore, data dictionary 482 can be stored in a database that is either remote and/or local to host system 440. For example, host system 440 may remotely access each merchant's database (e.g., by purchasing the right to access the merchant's database) at step 480 to request the necessary information. This may beneficially reduce upkeep costs for host system 440 since the merchant can be responsible for updating the database and maintaining the accuracy of the information. Alternatively, data dictionary 440 can be stored in a local database by, for example, downloading and/or manually entering the necessary information into the local database.

In some cases, host system 440 may be unable to suitably interpret all items on the receipt. This may occur when, for example, data dictionary 482 is missing information to properly identify a product or transaction type. In this case, these items can be stored as consumer clarification items 484 and the consumer can be prompted to clarify these items. For example, a web interface can be used to interact with the consumer to clarify the information on the receipt that is not yet fully understood, or the consumer can be asked to assist in the identification of manufacturers, brands, items, and the like. As another example, other communication means such as e-mail and text messaging can be used to interact with the consumer. In some embodiments, the consumer's responses can be integrated into data dictionary 482 to improve the interpretation of future receipts.

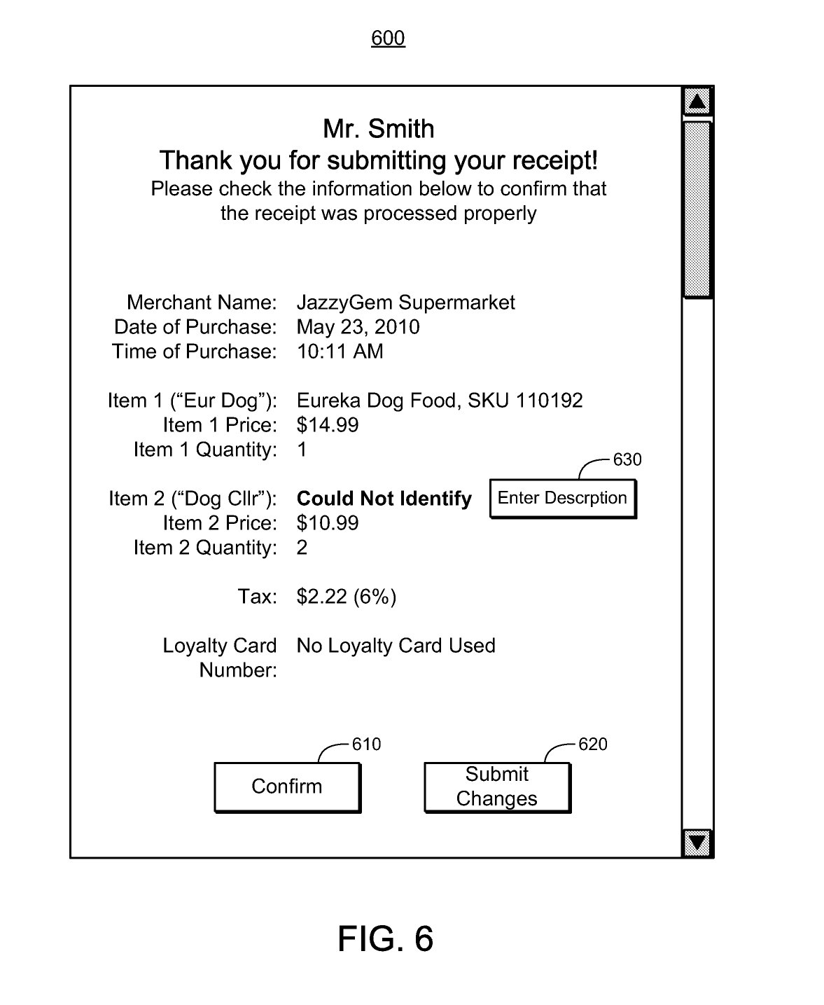

From the consumer's perspective, the process of uploading the receipt, interpreting the receipt, and requesting clarification can be provided in a single, seamless step. For example, in some embodiments, when a consumer submits a receipt through a web interface, the host system may immediately interpret the receipt and then provide the consumer with a confirmation screen that also requests approval of the interpretation. For example, a web interface such as interface 600 of FIG. 6 can be presented to the consumer. In interface 600, confirmation of the receipt upload can be provided (e.g., a message such as “thank you for submitting your receipt!” can be displayed) as well as a listing of the interpreted receipt component data. As an illustration, in FIG. 6 the merchant name has been identified as “JazzyGem Supermarket,” the first purchased item (e.g., with the receipt description of “EUR Dog”) has been interpreted as a product with SKU 110192, and so forth. A consumer can then be prompted to either confirm the interpretations (e.g., through “confirm” button 610) or submit changes to incorrect interpretations (e.g., though “submit changes” button 620). A consumer may also be prompted to aid in clarifying receipt component data that could not be properly interpreted. For example, FIG. 6 illustrates that the purchased item with the receipt description “Dog Cllr” could not be properly identified. A consumer may then be requested to submit a description of the item (e.g., a UPC code, or the like) through “enter description” button 630.

In addition, a consumer can also be prompted to provide other information not found on the receipt (e.g., through web interface 600, via e-mail, via text message, or via any other suitable communication means). For example, a consumer can be requested to answer a variety of survey questions regarding their attitudes, opinions, and behaviors, asked to provide demographic information on the purchaser and/or user of the purchased items, and the like.

Returning to FIG. 4, once the receipt has been suitably interpreted, the “final receipt data” can be stored in final receipt data archive 486. Final receipt data archive 486 can store information such as, for example, consumer categorization information 424 (e.g., whether an item was tax deductible, a work travel expenses, etc.,), receipt component data that may not require interpreting (e.g., merchant name, date of purchase, total price, etc., identified at step 470), interpreted transactions (e.g., unique product descriptions such as a UPC and/or particular transactions types such as a purchase, return, coupon, or sale identified at step 480), consumer clarification items 484 which the consumer has already clarified, or any other suitable items. In some embodiments, items which require consumer clarification but which have not yet been clarified may still be saved in final receipt data archive 486. However, in this case a metadata tag or other suitable tag can be used to indicate that this item has not yet been resolved.

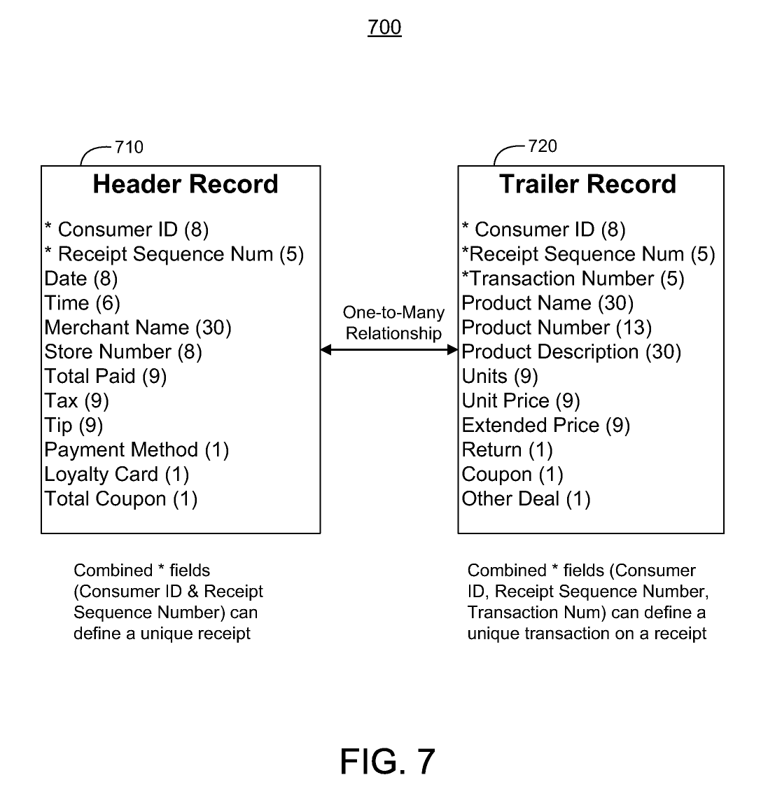

As an illustration, FIG. 7 shows data structure 700 for an exemplary final receipt data archive. Data structure 700 is shown for the purpose of illustration and not of limitation, and one skilled in the art could appreciate that a final receipt data archive could alternatively use any other suitable data structure. Data structure 700 can include header record 710 and trailer record 720. Header record 710 can include information that is particular to a single receipt. In other words, an instance of header record 710 can be created for each receipt that is submitted by a consumer. Header record 710 can include information such as the consumer's ID number, an ID to identify this particular receipt (e.g., “Receipt Sequence Num”), the date of the receipt, and the like. Header record 710 may generally not include information related to the particular transactions described on the receipt. Rather, as will be described below, this information can be included in the instances of trailer record 720. Every receipt stored by the host system (e.g., regardless of which consumer has submitted the receipt) can be uniquely identified by the combination of the Consumer ID and Receipt Sequence Num of header record 710.

The trailer record 720 can include information related to the transactions on the receipt identified in header record 710. For example, trailer record 720 can include information such as: the purchased product's name; the purchased product's UPC, SKU code, or the like (e.g., “Product Number”); the purchased product's description; and the like. There can be a “one-to-many” relationship between header record 710 and trailer record 720. In other words, each single receipt may list multiple transactions. Thus, every header record 710 (e.g., which can identify a single receipt) can be associated with one or more instances of a trailer record 720 (e.g., each of which can identify a single transaction). Trailer records can be matched to their corresponding header records by including the same Receipt Sequence Num as the header record of the desired receipt. Every transaction stored by the host system (e.g., regardless of which consumer has submitted the receipt or regardless of which receipt the transaction is listed on) can be uniquely identified by the combination of the Consumer ID, Receipt Sequence Num, and Transaction Number of trailer record 720.

In this manner, the final receipt data, as well as any other suitable information, that has gone through the interpretation processes illustrated by FIG. 4 are more likely to be accurately understood. As such, this information can enhance and expedite data processing and production (e.g., for use in marketing research). Using the improved data from these interpretation processes, more robust and valuable reports and other services can be provided to the consumers, to the host, and to other merchants. For example, FIG. 4 illustrates that various reports can be generated at step 490.

In particular, reports such as “consumer reports” and “host reports” can be generated at step 490. The consumer reports may, for example, encompass a wide range features that aid a consumer in manipulating, organizing, and understanding the information of their submitted receipts. For example, consumer reports can be generated which sort the receipts by a desired value and present this information to a consumer in a convenient and easy-to-interpret manner. The consumer reports can indicate receipt information that is sorted by values such as date, price of each purchase, total price of each receipt, tax, merchant, or by any other suitable values (e.g., such as any values found in final receipt data archive 486). This may aid the consumer in quickly spotting their purchasing behaviors, such as locating merchants or purchases on which the consumer tends to spend a greater amount of money. Similarly, the consumer reports can display consumer search results, where a consumer can search the receipt information for values such as merchants, date, coupon usage, sale usage, prices, or any other suitable values. Once again, this can aid the consumer in identifying their purchasing behaviors, such as identifying purchases on which the consumer tends to save a lot of money by using coupons.

Consumer reports can also be generated that present a calendar view to the consumer. For example, the consumer report can include a calendar view that lists values such as merchants visited, money spent, money saved on coupons or sales, number or price of purchases that were returned, and/or any other suitable information. Such a calendar view can provide a consumer with, for example, a graphical representation that is quick and easy to interpret of how the consumer's purchasing behavior varies over time.

Consumer reports such as tax deductible reports, travel expense reports, and budget reports can also be generated. For example, a tax deductible report can locate and display any purchases that have been tagged as tax deductible purchases (e.g., tagged through consumer categorization 424). Such a report can allow a consumer to quickly locate tax deductible purchases (e.g., and images of their corresponding receipts) to aid a consumer in filing for tax deductions. Similarly, a travel expense report can locate and display any purchases that have been tagged as work travel expenses purchases (e.g., tagged through consumer categorization 424), thus aiding a consumer in requesting reimbursement for travel expenses from their workplace. The budget reports can include any information suitable for aiding a consumer in maintaining and/or creating a budget. For example, the budget report can indicate information such as areas in which a consumer goes over budget, areas in which a consumer goes under budget, areas in which a consumer tends to spend too much money, days of the week on which a consumer tends to spend too much money, merchants on which the consumer tends to spend too much money, or any other suitable information.

As mentioned above, host reports can also be generated at step 490 of FIG. 4. The host reports can organize and present information that is of value to host system 440 and/or to merchants, such as marketing information that may reveal trends in consumer buying habits. As an illustration, the receipts of a wide group of consumers can be combined and compared to analyze and locate various market trends. Moreover, in addition to the information extracted from the receipts (e.g., merchants, dates, prices, coupons, sales, returns, and the like), information provided by the consumers about their opinions and/or demographics can also be incorporated into the host reports. For example, information such as whether a particular purchase was a need, whether a particular purchase was a want, whether a particular purchase was an impulse purchase, preferred brands, age of the purchaser, ethnicity of the purchaser, gender of the purchaser, residential information of the purchaser, or any other suitable information can be incorporated into the host reports.

Generally, such in-depth consumer behavior information may not be readily available to an entity for performing market research. However, due to the wide range of benefits provided to the consumer in exchange for sharing their purchasing information (e.g., benefits such as access to consumer reports, online access to images of their receipts, and the like), host system 440 can readily receive reliable information that accurately reflects a consumer's buying habits. The host reports can compare and organize this information to generate reports portraying a broad range of market trends, such as age trends, geographic buying trends, other demographic buying trends, sales trends, coupons that tend to be used by consumers (e.g., and that can result in the consumer purchasing other items from the merchant, thus resulting in an increased profit), popularity trends, trends in returning items, trends in impulse purchases, trends in items purchased out of need, trends in items purchased out of want, or any other suitable trends.

As mentioned above, FIG. 4 can illustrate processes used by host system 440 in generating such consumer and host reports, as well as parts of the system infrastructure that may be accessed in the process. For example, FIG. 4 illustrates seven archives: image archive 452, text & metadata archive 462, receipt constructs library 472, receipt component data archive 474, data dictionary 482, consumer clarification items 484, and final receipt data archive 486. The information in image archive 452, receipt constructs library 472, data dictionary 482, and final receipt data archive 486 may generally be stored in relatively permanent storage (e.g., as opposed to temporary memory such as RAM). As an illustration, when comparing these archives to the components of FIG. 2, image archive 452, receipt constructs library 472, data dictionary 482, and final receipt data archive 486 of FIG. 4 may correspond to image archive 233, receipt constructs library 232, data dictionary 234, and final receipt data archive 235 of FIG. 2, respectively. In contrast, the information in text & metadata archive 462, receipt component data archive 474, and consumer clarification items 486 of FIG. 4 may only be stored temporarily. For example, the information in text & metadata archive 462 may only be required temporarily until the receipt has been fully interpreted and its interpreted text stored in final receipt data archive 235. Accordingly, in some embodiments, text & metadata archive 462, receipt component data archive 474, and consumer clarification items 486 can be implemented through a temporary memory, such as RAM 237 of FIG. 2.

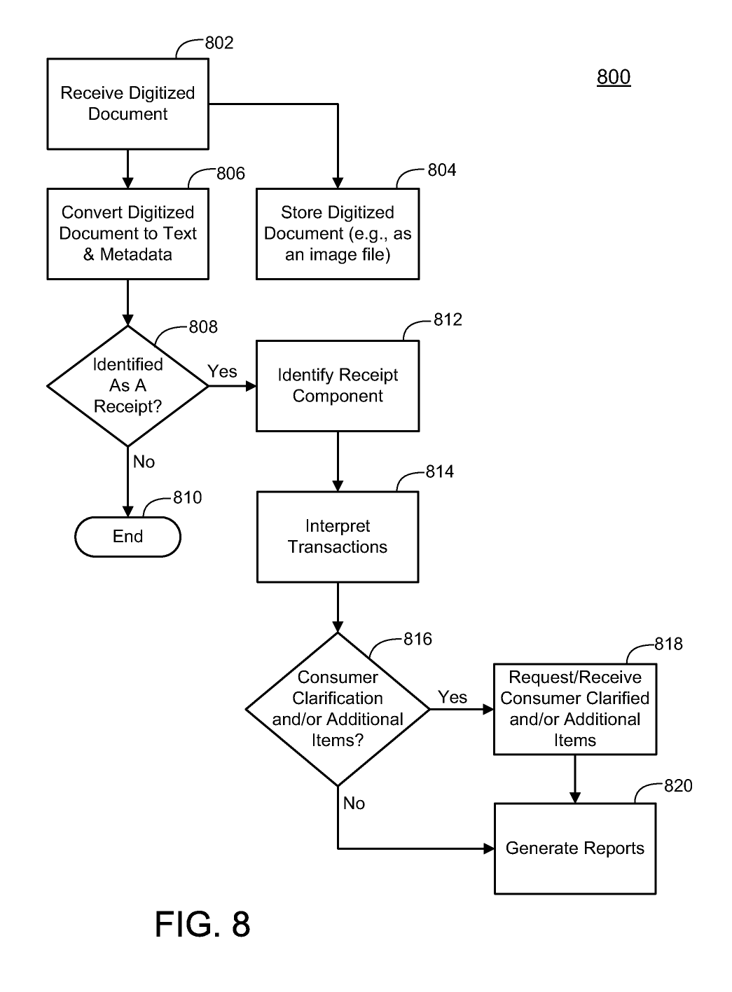

Moreover, in addition to the infrastructure, FIG. 4 can illustrate various steps that host system 440 may follow in order to interpret the receipts and generate consumer and/or host reports (e.g., as illustrated by steps 450, 460, 470, 480, and 490). FIG. 8 shows process 800 that can illustrate such steps in greater detail. For example, process 800 can be implemented by a processor of host system 440, such as processor 236 of FIG. 2. Since many of the steps in process 800 can correspond to and/or overlap with the steps of FIG. 4, for brevity's sake these steps may only be described briefly.

At step 802, a consumer's digitized document can be received. For example, the digitized document can be received via a web interface, via e-mail (e.g., as an attachment or as text in the e-mail), via a handheld communication device (e.g., as a MMS, in an e-mail, and the like), via a dedicated smart phone application, or via any other suitable communication means.

The digitized document can be stored (e.g., stored in image archive 233 of FIG. 2 as an image file, or as any other suitable file type) at step 804 and can be converted to text and metadata at step 806. The digitized document can be converted to text and metadata through any suitable process, such as, for example, a software application such as OCR, manual text entry, or through any other suitable process.

The digitized documents can be analyzed to identify which documents are receipts at step 808. In response to the digitized document being identified as a receipt, the receipt can be suitably interpreted and reports generated though steps 812 and onwards. In response to the digitized document not being a receipt, however, process 800 can end at step 810 without further processing. However, in some embodiments, step 808 can be omitted such that any type of digitized document can be interpreted and used to generate reports, or otherwise processed through steps 812 and onwards. As an illustration, other digitized documents such as bills, travel itineraries, and the like can be used to generate marking research reports, consumer budgets, consumer calendars, or any other suitable reports which can be beneficial to the consumers, the host, and/or merchants.

At step 812, the receipt components can be identified from the receipt. For example, as described with regards to FIG. 4, the receipt component data can include information linking the text determined at step 806 to their meaning Thus, the receipt component data can identify information such as the date of purchase, the time of purchase, the total price, the payment method, coupon information, returned item information, card information, tax information, sales items information, an array of details associated with the transactions (e.g., the item description, the item quantity, the price of the item, and the like), and any other suitable relevant receipt information. The receipt components can be identified using the text recognized at step 804, the metadata recognized at step 804, and a receipt constructs library (e.g., such as receipt constructs library 232 of FIG. 2).

The transactions listed on the receipt can be interpreted at step 814. For example, the description of a transaction found on the receipt can be compared to a data dictionary (e.g., data dictionary 234 of FIG. 2) to determine a more exact meaning of the transaction. The specific product in the transaction can be identified (e.g., by determining a UPC for the item, a SKU code for the item, a brand name and item number for the item, or the like), and/or the type of transaction can be determined (e.g., such as whether the transaction was a purchase, a return, a sales purchase, a purchase using a coupon, or the like).

Process 800 can determine whether the consumer's input is required to clarify parts of the receipt and/or to provide additional information at step 816. For example, it may be desirable to have the consumer provide additional information such as opinions on purchases, survey answers, or the like. As another example, the host system may have been unable to identify all receipt components at step 812 and/or was unable to interpret all the transactions at step 814. Thus, in this case the consumer can be prompted to provide this information at step 818. Suitable reports can then be generated (e.g., consumer reports and/or host reports) at step 820 that include the information generated from the receipts by process 800 (e.g., generated at step 812, 814, 818, or any other suitable step).

The host system can also provide any other suitable features for the consumer. For example, in some embodiments, a feature can be provided that automatically searches for and removes duplicate receipts (e.g., in the event that a consumer mistakenly submits the same receipt twice). As another example, a feature can be provided that automatically assembles a single receipt together from multiple files. This may be beneficial for scenarios where a consumer's receipt is too long to be scanned in a single page, and thus is submitted as two separate files. As another illustration, this feature could benefit a consumer who accidentally submitted only half of a receipt. Rather than requiring removal of the partial receipt from the system and then subsequent re-scanning and submission of the entire receipt, the consumer can merely scan and upload the missing half. The host system may then automatically join the two halves together into a full receipt.

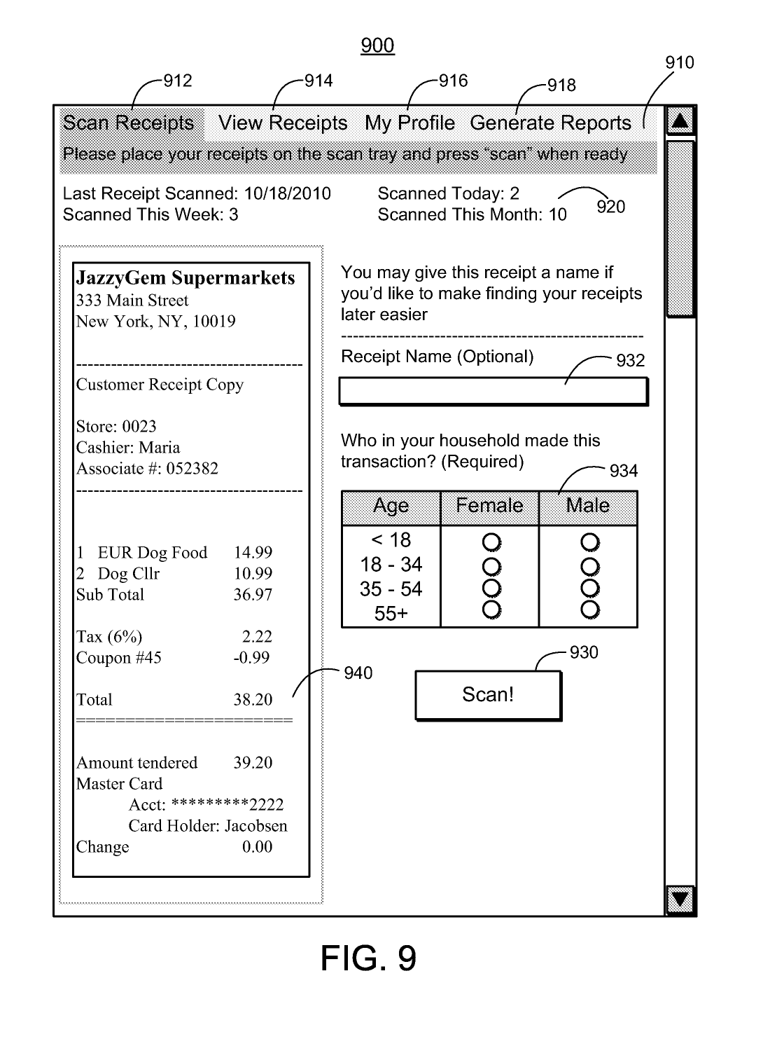

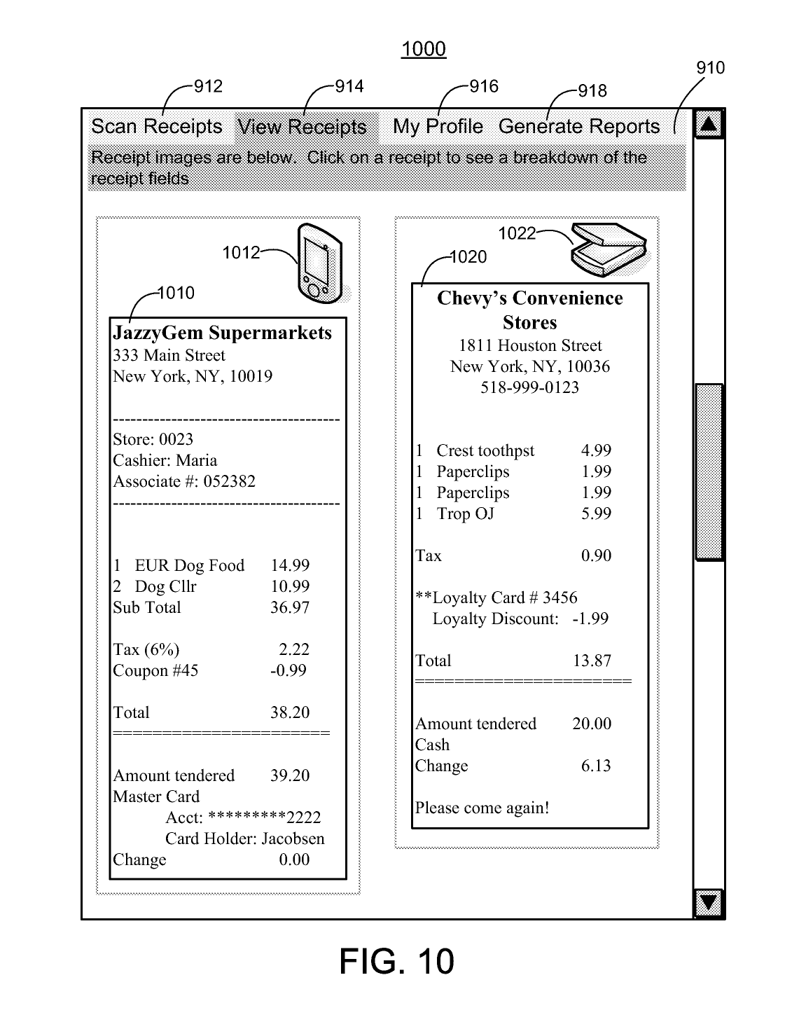

FIGS. 9 and 10 show illustrative web interfaces 900 and 1000, respectively, for allowing a consumer to submit receipts, view stored receipts (e.g., receipts which are stored in image archive 233 of FIG. 2), generate reports, and/or otherwise process the information in the submitted receipts. Web interfaces 900 and 1000 are shown for the purpose of illustration and not of limitation, and one skilled in the art could appreciate that any other suitable web interface layout could alternatively be used. Web interfaces 900 and 1000 can include menu bar 910 for navigating through the web interface. Menu bar 910 can include a variety of consumer options such as, for example, scan receipts tab 912, view receipts tab 914, my profile tab 916, generate reports tab 918, or any other suitable tabs. In particular, web interface 900 can correspond to an interface when scan receipts tab 912 is selected and web interface 1000 can correspond to an interface when view receipts tab 914 is selected.

My profile tab 916 can bring a consumer to an interface where user profile information can be entered such as, for example, username, password, consumer's name, address, age, gender, other demographic information, purchase preferences, or any other suitable user profile information. A consumer can also register e-mail addresses and phone numbers (e.g., in order to submit receipts via e-mail and via a handheld communication device, respectively) through my profile tab 916. Generate reports tab 918 can bring a consumer to an interface for generating any suitable consumer reports. For example, as mentioned above, consumer reports can be generated via tab 918 which: sort purchases (e.g., by date, by item name, by price, and the like); search the purchases for desired criteria such as price, merchant name, time period, and the like; list tax deductible purchases; list travel expense purchases; show a calendar listing of purchasing information; or show any other suitable consumer report information.

In some embodiments, web interface 900 can include activity header 920 that lists a consumer's recent activity on the web interface. For example, information such as when a receipt was last scanned or how many receipts have been scanned recently can be listed in activity header 920. Such information can encourage a consumer to visit the web interface often and routinely submit receipts.

A consumer can directly submit receipts through web interface 900 by using an option such as scan button 930. As an illustration, in response to selecting scan button 930, web interface 900 can initiate communication with the consumer's scanner Web interface 900 may then direct the consumer's scanner to begin scanning and may then automatically upload the scanned receipt (e.g., upload to image archive 233 of FIG. 2) upon completion of the scanning In some embodiments, a consumer can be requested to provide optional and/or required information when submitting receipts through scan button 930. For example, optional information such as a receipt name can be input through text box 932. As another example, required information such as demographic information can be provided through input 934.

Once a receipt has been submitted (e.g., though scan button 930), receipt image 940 of the submitted receipt can be automatically presented to the consumer. Alternatively or additionally to displaying receipt image 940, upon submission a consumer can be provided with a confirmation interface such as interface 600 of FIG. 6.

Web interface 1000 can allow a consumer to view submitted receipts by selecting, for example, view receipts tab 914. Web interface 1000 can show images of the submitted receipts, the final receipt data (e.g., stored in final receipt data archive 235 of FIG. 2), or both. As an illustration, web interface 1000 is illustrated as displaying receipt images 1010 and 1012. The final receipt data for a particular receipt can then be displayed by selecting that receipt's image. For example, selecting receipt image 1010 can bring up a web interface listing information such as:
Merchant name: JazzyGem Supermarkets
Merchant Address: 333 Main Street, New York N.Y., 10019
Item 1: (EUR Dog Food): Eureka Dog Food, SKU 110192
Item 1 Price: $14.99
   and so forth. In some embodiments, each receipt image can include an indicator designating how the receipt was submitted by the consumer. For example, indicator 1012 can designate that receipt 1010 was submitted via a handheld communication device, indicator 1022 can indicate that receipt 1020 was submitted via a scanner and web interface, and so forth. Other indicators can be included that show a receipt was submitted by e-mail, by MMS messaging, by a smart phone dedicated application, or via any other suitable way.

As mentioned above, a host system can obtain demographic and other information regarding a consumer and their purchasing behavior through the systems and methods described herein. As a particular illustration, a host system can obtain demographic information regarding a consumer when that consumer enters this information through my profile tab 916 of FIG. 9. Additionally or alternatively to such “inside” sources, a host system can also obtain information regarding a consumer through outside sources. As an illustration, the host system can obtain information relating to the consumer from previous market research surveys in which the consumer participated. For example, a consumer may have a unique identifier that he or she uses for various market research surveys (e.g., a panelist identification number) and this unique identifier may be used to obtain information relating to the consumer from one or more of the other market research surveys. As another illustration, the host system can utilize social networking sites (e.g., Facebook, MySpace, Friendster, etc.), blogging sites (e.g., Twitter, Xanga, etc.) or other suitable websites to interact with consumers and pull information regarding a consumer's preferences, demographic information, habits, and the like. As another illustration, the host system can obtain access point information when a consumer accesses the Internet (e.g., such as when the user accesses the Internet to upload a receipt), thus allowing the host system to obtain geographic information related to a consumer. As another illustration, phones can oftentimes “geotag” a digital photograph when taking a picture. For example, when taking a digital photograph, a phone can utilize an integrated global positioning system (“GPS”) to determine the current location. The digital photograph can then be geotagged with this current location by writing the GPS location into the digital photograph's metadata. The host system may then obtain geographic information regarding a consumer by accessing the geotagged metadata of receipt digital photographs.

Thus, the techniques described herein discuss various embodiments that can make these techniques both commercially attractive and unique. For example, receipts can be collected, digitized, and organized from multiple sources. Receipts can come in different forms and on different media. The embodiments described herein can capture all of these various sources and forms of receipts. For example, paper receipts can be scanned and transmitted from a personal computer. Electronic receipts can be forwarded via e-mail. Paper receipts can be photographed with an inherent camera of a mobile phone and transmitted via e-mail or MMS. A dedicated smart phone application could be used to capture a receipt's image using the smart phone's camera and transmitted automatically.

As another example of the commercially attractive and unique aspects of the embodiments described herein, scanning of receipts can be conducted via a web interface. Moreover, this web interface can be easily configured and user-friendly for the consumer. For example, the scanning of documents can traditionally require two software components on the consumer's computer: (1) application software with which the consumer interacts, and (2) a device driver that manages the communication between this application software and the scanning peripheral. The embodiments described herein can include a web interface that interacts directly with the device driver. Thus, application software may not be required. Rather, the only software installation that may be required is the device driver.

Additionally, consumers can be provided with free access to all their submitted documents, thus providing a compelling value proposition to the participating consumer. In particular, consumers can be provided with a valuable, reliable, and secure method to store and search records of their transactions for as long as they participate, as well as providing the opportunity to generate a wide range of consumer reports. A consumer is thus incentivized to continuously and thoroughly submit their receipts. This, in turn, can provide the host system with access to vast amounts of accurate consumer purchasing information, which can be invaluable to marketing research.

The processes and embodiments discussed herein are intended to be illustrative and not limiting. Persons skilled in the art can appreciate that steps of the processes discussed herein can be omitted, modified, combined, or rearranged, and any additional steps can be performed without departing from the scope of the invention. Moreover, it will be apparent to those of ordinary skill in the art that methods and processes involved in the invention may be embodied in a computer program product that includes a machine readable and/or usable medium. For example, such a computer usable medium may consist of a read-only memory device, such as a CD ROM disk or conventional ROM device, or a random access memory, such as a hard drive device or a computer diskette, or flash memory device having a computer readable program code stored thereon.

What is claimed is:

1. A method for a consumer to submit documents to a host system, the method comprising:
converting a first consumer document into a digitized format with an electronic device system of the consumer; and
transmitting the converted consumer document to the host system using the electronic device system, wherein the host system:
stores the converted consumer document;
extracts purchasing information from the converted consumer document; and
produces a report based at least in part on the extracted purchasing information.

2. The method of claim 1, further comprising:
receiving, from the host system, on-line access to the stored consumer document.

3. The method of claim 1, further comprising:
receiving, from the host system, access to the report in exchange for transmitting the converted consumer document.

4. The method of claim 1, wherein:
the electronic device system includes a scanner and a computer;
the converting comprises scanning the first consumer document using the scanner; and
the transmitting comprises sending the scanned consumer document to the host system as an e-mail attachment via the computer.

5. The method of claim 1, wherein:
the electronic device system includes a scanner and a computer;
the converting comprises scanning the first consumer document using the scanner; and
the transmitting comprises uploading the scanned consumer document to the host system via a web interface accessed by the computer.

6. The method of claim 1, wherein:
the electronic device system includes a handheld communication device;
the converting comprises taking a digital photograph of the first consumer document using the handheld communication device; and
the transmitting comprises sending the digital photograph to the host system through a multimedia messaging service of the handheld communication device.

7. The method of claim 1, wherein:
the electronic device system includes a handheld communication device;
the converting comprises taking a digital photograph of the first consumer document using the handheld communication device; and
the transmitting comprises sending the digital photograph to the host system through a dedicated smart phone application of the handheld communication device.

8. The method of claim 1, wherein the first consumer document includes a receipt of at least one purchase made by the consumer.

9. The method of claim 8 wherein the report comprises a consumer report indicating which purchases of the receipt are tax-deductible by the consumer.

10. The method of claim 8, wherein the report comprises a consumer report indicating which purchases of the receipt can be reimbursed to the consumer as work travel expenses.

11. The method of claim 1, wherein the report comprises a consumer report indicating at least one of:
search results for a particular term provided by the consumer; and
sort results for a particular field provided by the consumer.

12. The method of claim 1, wherein the report comprises a consumer report displaying at least one of:
consumer budget information; and
a calendar listing of the consumer's shopping trends, wherein the host system determined the consumer's shopping trends and the consumer budget information from the purchasing information extracted from the converted consumer document.

13. The method of claim 12, wherein the consumer's shopping trends comprise at least one of:
particular days on which items are purchased from a particular merchant;
particular days on which particular items are purchased by the consumer;
particular days on which a particular payment method is used; and
an amount of money the consumer spends on each day.

14. A method for a host system to process receipts received from a consumer, the method comprising:
receiving a first receipt from the consumer, wherein the first receipt is in a digital format and is received by communications circuitry of the host system;
converting the first receipt into text and metadata with a processor of the host system;
identifying final receipt data of the first receipt by processing at least the text and metadata with the processor, wherein the final receipt data includes at least one of merchant information of the first receipt, transaction information of the first receipt, and payment information of the first receipt;
analyzing the final receipt data with the processor to determine market trends that are based at least partially on the final receipt data; and
generating, with the processor, at least one host report indicating the determined market trends.

15. The method of claim 14, wherein the receiving comprises:
monitoring an e-mail inbox associated with the host system for new e-mails; and
in response to determining a new e-mail has been received, extracting the first receipt from the new e-mail.

16. The method of claim 15, wherein the first receipt is extracted from at least one of an attachment included with the new e-mail and a textual body of the new e-mail.

17. The method of claim 14, wherein:
the text comprises a digital representation of at least one of letters, numbers, and symbols that are printed on the first receipt; and
the metadata comprises contextual information indicating a location of the letters, numbers, and symbols on the first receipt.

18. The method of claim 14, wherein converting the first receipt into text comprises extracting the text from the first receipt using an optical character recognition system.

19. The method of claim 14, wherein the determined market trends comprise at least one of demographic buying trends, geographic buying trends, coupon usage trends, sales item purchase trends, returned item trends, and popular item tends.

20. The method of claim 14, wherein analyzing the final receipt data to determine market trends comprises:
analyzing final receipt data of a plurality of receipts received from a plurality of consumers to determine broad market trends.

21. The method of claim 14, further comprising:
storing an image of the first receipt in an online image archive that is accessible by the consumer.

22. The method of claim 14, further comprising:
receiving information from the consumer indicating whether purchases indicated on the first receipt are at least one of an impulse purchase, a necessity purchase, and a non-necessity purchase; and
wherein the determined market trends comprise at least one of impulse purchase trends, necessity purchase trends, and non-necessity purchase trends.

23. The method of claim 14, further comprising:
displaying the final receipt data to the consumer; and
prompting the consumer to provide at least one of:
a confirmation that the final receipt data is correct; and
a correction to the final receipt data.

24. A host system for processing consumer receipts, the host system comprising:
an image archive operable to store images of a plurality of receipts received from a plurality of consumers;
a receipt constructs library including receipt constructs data for determining a meaning of text located on a receipt;
a data dictionary including transaction data for interpreting transactions of a receipt; and
a processor operable to:
extract text and metadata from each receipt of the plurality of receipts;
identify receipt components from each receipt using the extracted text, the extracted metadata, and the receipt constructs data;
interpret transactions of each receipt using the transaction data of the data dictionary; and
generate reports using the identified receipts components of the plurality of receipts and the interpreted transactions of the plurality of receipts.

25. The host system of claim 24, further comprising:
a server operable to host a web interface, wherein the web interface allows a particular consumer to access images of receipts received from that particular consumer.

26. The host system of claim 24, further comprising:
a server operable to host a web interface, wherein the web interface allows a consumer to access a particular set of generated reports, wherein the particular set of generated reports manipulate identified receipts components and interpreted transactions of receipts received only from that consumer.

27. The host system of claim 24, further comprising:
a server operable to host a web interface, wherein the web interface allows a merchant to access the generated reports, and wherein the generated reports indicate broad market trends of the plurality of consumers.

28. The host system of claim 24, wherein the plurality of receipts are issued by a plurality of merchants, and wherein a set of receipt constructs data is included in the receipt constructs library for each merchant of the plurality of merchants.

29. The host system of claim 24, wherein the transaction data includes information for:
interpreting types of transactions; and
determining a unique identifier for an item of a transaction.

30. The host system of claim 29, wherein the types of transactions comprise at least one of a purchase of an item, a return of an item, a purchase of a sale item, a coupon used in purchasing an item, and a loyalty account used in purchasing an item.

31. The host system of claim 29, wherein the unique identifier for an item of a transaction comprises at least one of:
a universal product code;
a stock keeping unit code; and
a combination of a brand name and an item number.

32. The host system of claim 24, further comprising:
a final receipts data archive operable to store the identified receipts components and interpreted transactions of the plurality of receipts.

33. The host system of claim 24, wherein the processor is further operable to:
identify a portion of text of a particular receipt that requires consumer clarification;
identify a particular consumer associated with the particular receipt; and
provide a prompt to the particular consumer requesting clarification of the identified portion of text.

34. The host system of claim 24, wherein the processor is further operable to:
provide a prompt to a consumer requesting additional information;
receive the additional information from the consumer; and
generate reports using the additional information, the identified receipts components of the plurality of receipts, and the interpreted transactions of the plurality of receipts.

35. The host system of claim 34, wherein the additional information comprises at least one of consumer responses to a survey, consumer demographic information, whether a consumer purchased a particular item on impulse, whether a consumer purchased a particular item out of necessity, and whether a consumer purchased a particular item out of want.

36. The host system of claim 24, wherein the processor is further operable to:
identify at least two receipts of the plurality of receipts that are the same receipt; and
delete all but one of the at least two receipts from the image archive.

37. A method for a host system to receive receipts from consumers, the method comprising:
monitoring, with a processor of the host system, an e-mail inbox to determine whether a new e-mail has been received;
in response to determining a new e-mail has been received, extracting an e-mail source from the new e-mail with the processor;
comparing, with the processor, the e-mail source to a database of registered e-mail addresses to determine whether the e-mail source matches a registered e-mail address;
in response to determining the e-mail source matches, extracting e-mail content of the new e-mail with the processor; and
storing the e-mail content in an online archive associated with the e-mail source.

38. The method of claim 37, wherein the e-mail inbox is associated with an e-mail account of the host system.

39. The method of claim 37, wherein the monitoring comprises at least one of:
checking the e-mail inbox continuously; and
checking the e-mail inbox once every set period of time.

40. The method of claim 37, wherein the e-mail source comprises an e-mail address from which the new e-mail was sent.

41. The method of claim 37, wherein the e-mail content comprises receipt information of a purchase completed by a consumer who is associated with the e-mail source.

42. The method of claim 37, further comprising:
in response to determining the e-mail source does not match, automatically replying to the e-mail source with an error message.

43. The method of claim 37, further comprising:
manipulating the e-mail content to generate at least one of a consumer report and a host report.
